(19) United States
(12) Patent Application Publication
(10) Pub. No.: US 2015/0275778 A1
(43) Pub. Date: Oct. 1, 2015

(54) SYSTEM FOR A THERMODYNAMIC CYCLE, CONTROL UNIT FOR A SYSTEM FOR A THERMODYNAMIC CYCLE, METHOD FOR OPERATING A SYSTEM, AND ARRANGEMENT WITH AN INTERNAL COMBUSTION ENGINE AND A SYSTEM

(71) Applicant: MTU Friedrichshafen GmbH, Friedrichshafen (DE)

(72) Inventors: Gerald FAST, Markdorf (DE); Tim HORBACH, Friedrichshafen (DE); Max LORENZ, Friedrichshafen (DE); Jens NIEMEYER, Friedrichshafen (DE); Daniel STECHER, Pfulldendorf (DE); Niklas WAIBEL, Friedrichshafen (DE); Mathias MÜLLER, Friedrichshafen (DE)

(21) Appl. No.: 14/674,398

(22) Filed: Mar. 31, 2015

(30) Foreign Application Priority Data
Mar. 31, 2014 (DE) 10 2014 206 038.9

(51) Int. Cl. F02D 15/02; F02B 75/04; F02D 28/00

(52) U.S. Cl. CPC F02D 15/02; F02D 28/00; F02B 75/04

(57) ABSTRACT

A system for a thermodynamic cycle with a circuit for a working medium, wherein a medium quantity-variation device is provided, which is connected to the circuit in such a way and so configured that the quantity of working medium present in the circuit is changeable by the medium quantity-variation device during the operation of the system.

### CROSS-REFERENCE TO RELATED APPLICATIONS

The present application claims priority of DE 10 2014 206 038.9, filed Mar. 31, 2014, the priority of this application is hereby claimed and this application is incorporated herein by reference.

### BACKGROUND OF THE INVENTION

The invention pertains to a system for a thermodynamic cycle, to a control unit for a system for a thermodynamic cycle, to a method for operating such a system, and to an arrangement with an internal combustion engine and such a system.

Systems of the type in question here are known in principle. They comprise a circuit for a working medium, the circuit typically being configured as a closed system with a permanently fixed content of working medium. Such systems can be configured to carry out an organic Rankine cycle, which is similar to the Clausius-Rankine cycle but operates with an organic working medium at lower working temperatures, as a result of which it is especially adapted to the use of waste heat; systems of this type in particular comprise a fixed content of working medium, which includes a safety reserve. There is therefore more working medium in the circuit of the system than would actually be necessary. This reduces the power yield of the system and imposes limitations during transient operation.

### SUMMARY OF THE INVENTION

The invention is therefore based on the goal of creating a system which does not suffer from the disadvantages cited. The invention is also based on the goal of creating a control unit for such a system, a method for operating such a system, and an arrangement with an internal combustion engine and such a system, wherein again the disadvantages cited above do not occur.

The goal is achieved in a system that is characterized by a device for varying the quantity of working medium, the device being connected to the circuit of the system in such a way that this medium quantity-variation device can vary the quantity of working medium present in the circuit during the operation of the system. The system therefore does not comprise a permanently fixed content of working medium; on the contrary, the content of the system is variable during the operation of the system by means of the medium quantity-variation device. It can in particular be adjusted dynamically during operation, so that it can always be reduced as much as possible but never so far as to interfere with stable operation. As a result, the power yield of the system can be increased, in particular at a design point and at partial load. This also improves the quality of the automatic control of the system. By means of the medium quantity-variation device, it is also possible to compensate for the losses through leakage which occur as the system ages.

It has been observed in particular that the content of working medium in a circuit for a thermodynamic cycle, especially for an organic Rankine cycle—called in brief the ORC process—is an essential parameter which determines the pressure level in the condenser of the circuit. This in turn determines the power yield of the process. To allow optimal operation with respect to power yield, the content of working medium must be as small as possible, wherein, however, there is a lower limit determined by the stability of the process control. For example, if the content is too small, cavitation can occur in a conveying device for the working medium through the circuit. It has also been found that the optimal content for the circuit depends on the operating point of the system, i.e., it varies with the operating point of the system. These limitations made it necessary in the past to provide a safety reserve in closed system circuits with a permanently fixed content of working medium; this reserve then ensures stable operation at all operating points. The sacrifice of power yield simply had to be tolerated. This is no longer necessary now, however, because the content of the working medium in the system proposed here can be varied by means of the quantity-variation device during operation.

An exemplary embodiment is characterized in that the medium quantity-variation device comprises a reservoir for the working medium, the reservoir being in fluid connection with the circuit. As a result, the quantity of working medium circulating through the circuit can be varied by communication with the reservoir in a manner which is very simple not only in terms of construction but also in terms of technology, in that either working medium is withdrawn from the reservoir and fed into the circuit or working medium is withdrawn from the circuit and conducted to the reservoir. It is therefore possible, simply and directly, to increase the content in the circuit by feeding medium into the circuit from the reservoir or to decrease it by withdrawing medium from the circuit and conducting it to the reservoir.

Another exemplary embodiment is characterized in that the reservoir comprises a volume-changing device, which is set up to change the volume of the reservoir which the working medium can fill. By means of the volume-changing device, therefore, the volume available to the working medium in the reservoir can be changed. As a result, working medium can be either displaced from the filling volume of the reservoir by making that volume smaller or conversely withdrawn from the circuit and fed into the reservoir by increasing the filling volume. In this case, the reservoir is preferably configured as a closed container—without fluid connection to an environment of the system—in order that the function above can be implemented with a filling volume which, in a manner of speaking, is able to “breathe”.

Another exemplary embodiment of the system is characterized in that the fluid connection between the reservoir and the circuit is free of control elements or cross section-adjusting elements. In particular, the fluid connection is preferably free of valves. There is therefore a permanent, constant fluid connection between the reservoir and the circuit. The fluid connection thus has an especially simple and low-cost configuration. The configuration of the fluid connection without control elements or cross section-adjusting elements is especially favorable in connection with a volume-changing device wherein working medium can be withdrawn from, or discharged into, the circuit simply and directly by changing the filling volume.

To this extent it can be seen that a medium quantity-variation device comprising a reservoir with a volume-changing device has no need for pumps or valves, so that it has a very simple and low-cost structure. What is provided is in essence a supply tank of variable volume, by means of which the quantity of working medium in the circuit can be varied.

Another embodiment of the system is characterized in that the volume-changing device comprises a piston, which is accommodated movably in a cylinder surrounding the filling volume. In this way, a reservoir of variable filling volume can be realized in a very simple manner in terms of both construction and technology. The piston is guided closely against the cylinder wall, so that it is decreases the filling volume when acting in a first direction, thus forcing working medium from the cylinder into the circuit, wherein it increases the filling volume when acting in a second direction, thus, in what amounts to a sucking action, drawing working medium from the circuit into the cylinder.

The system preferably comprises a displacement device, which is functionally connected to the piston and is configured to move the piston. The displacement device can be configured as a motor, preferably as an electric motor, especially as a rotary or linear motor, which is functionally connected to the piston in some suitable way.

Alternatively, it is possible for the reservoir to be configured as a flexible reservoir, in particular as a reservoir with flexible walls. For example, the reservoir can be configured as a flexible tube or bellows. It is then possible, for example, for the filling volume in the reservoir to be changed by changing the external pressure acting on the reservoir. In this way, too, a simple-to-build, low-cost, and yet precisely operating medium quantity-variation device can be provided.

Quite generally it is preferable for the reservoir to comprise a closed volume with flexible walls, wherein the filling volume is variable by displacement or deformation of the walls.

Another embodiment of the system is characterized by a conveying device, which is set up to convey working medium from the reservoir to the circuit and/or from the circuit to the reservoir. The conveying device is preferably arranged along the fluid connection. The conveying device is preferably set up to convey working medium from the reservoir to the circuit in a first functional position, wherein it conveys working medium from the circuit into the reservoir in a second functional position. Thus, by means of the conveying device, working medium can be removed from the circuit and conveyed into the reservoir as needed, wherein the conveying device can also convey working medium from the reservoir into the circuit as needed to increase the quantity there. The conveying device is preferably configured as a pump, especially as a reversible pump, and therefore as a pump which can be operated in two different active directions—corresponding to the previously explained two functional positions. The arrangement of a conveying device makes possible an especially exact metering into, and/or withdrawal of working medium from, the circuit, as a result of which the behavior of the system can be regulated with an especially high degree of precision.

Another embodiment of the system is characterized in that a control element is arranged in the fluid connection, this control element being set up to change the open cross section of the fluid connection. In a preferred, simplest embodiment, the control element comprises exactly two functional positions, namely, a first position in which the fluid connection is closed, and a second position, in which the fluid connection is open. By means of the control element, the reservoir can be separated from the circuit in operating states of the system in which there is not to be any variation in the amount of working medium filling the circuit. The control element is opened only in the operating states in which the amount of working medium filling the circuit is to be changed. In an exemplary embodiment such as this, the control element can be configured very simply and cheaply. Alternatively, the control element comprises a plurality of functional positions between the previously mentioned extremes, so that the open cross section can be varied in discrete steps or continuously between the two extremes. As a result, the feed of working medium into the circuit and the withdrawal from the circuit can be regulated with an especially high degree of sensitivity. The control element is preferably configured as a valve.

Another embodiment of the system is characterized in that the reservoir comprises a pressure equalization connection to an environment of the system. In this case it is not configured as a closed container but rather as an atmospheric container. This offers the advantage that the reservoir itself is not under pressure, which increases the safety of the system, wherein the requirements on the configuration of the reservoir are simplified.

A system is preferred which comprises a conveying device and a control element in the fluid connection, wherein the reservoir simultaneously comprises a pressure equalization connection to the environment of the system. In particular, the conveying device and the control element make it possible to configure the reservoir as an atmospheric supply tank, because the circuit can be separated from the environment by means of the control element, and wherein the conveying device can overcome any pressure difference between the reservoir and the circuit, so that the working medium, which has been relieved of pressure in the reservoir, can be fed into the pressurized circuit by means of the conveying device.

Another embodiment of the system is characterized by a control unit, which is configured to change the quantity of working medium present in the circuit by means of the medium quantity-variation device as a function of at least one operating parameter of the system. The control unit is therefore configured and set up, first, to acquire at least one operating parameter of the system. It is preferably functionally connected to at least one sensor for detecting an operating parameter of the system. The control unit is also functionally connected to the medium quantity-changing device so that the amount of working medium present in the circuit can be changed by the medium quantity-changing device. This is advantageous, because it has been found that, especially with respect to the power yield of the system, the optimal quantity of working medium filling the circuit varies with the operating point of the system. When the filling quantity is varied by the control unit with the help of the medium quantity-variation device as a function of the operating point, the system can therefore be operated under optimal conditions, in particular with an optimal power yield, and at the same with stability. The amount of working medium in the circuit is then never excessive at any operating point of the system, so that there is no need to tolerate a sacrifice of power. At the same time, it can be ensured that a sufficiently large amount of medium is present in the circuit at every operating point, i.e., sufficient to ensure stable operation.

In another embodiment, the control unit is configured to regulate the quantity of working medium in the circuit automatically as a function of at least one operating parameter of the system. As a result, the filling quantity can be adjusted as a function of the operating point with great accuracy.

The power delivered by the system, the heat input into the system, the superheating of the working medium in the system, the wet steam content of the working medium in the circuit, the rotational speed of an expansion device of the system, a pressure upstream of the expansion device in the circuit, and/or a temperature and/or a pressure in the condenser can be used as the operating parameter.

In a further embodiment of the system, a cavitation sensor is arranged in the area of a conveying device of the circuit, wherein the control unit is configured to change the quantity of working medium present in the circuit by means of the medium quantity-variation device as a function of a signal sent by the cavitation sensor.

In this case, the signal sent by the cavitation sensor is used as an operating parameter of the system. The conveying device of the circuit is configured to convey the working medium through the system circuit, wherein the device is preferably configured as a feed pump. The cavitation sensor is configured and arranged in such a way that preferably the onset of cavitation or operating conditions under which the onset of cavitation can be expected can be detected in the area of the conveying device. If the target condition is detected, the quantity of medium in the circuit is increased to suppress or to prevent cavitation. In this way it is possible to operate the system in stable fashion and to protect the conveying device of the circuit from the damage which could be caused by cavitation.

According to another embodiment of the system, the system is set up to carry out an organic Rankine cycle—in short, an ORC process. The system preferably comprises an evaporator, an expansion device, a condenser, and the conveying device, arranged in series in the circuit, in the flow direction of the working medium. The working medium takes up heat in the evaporator, as a result of which it is vaporized. In the expansion device, the working medium is expanded, wherein it performs mechanical work. In the condenser, the working medium is cooled, preferably condensed, whereupon it is sent back to the conveying device, which closes the circuit. The ORC process is especially well adapted to the use of heat at a lower temperature level than that used in the classical Clausius-Rankine cycle and therefore to stationary applications, such as for the use of heat in a geothermal power plant or for the use of the waste heat of industrial processes or of internal combustion engines in both stationary and in mobile applications. The expansion device is preferably a volumetric device such as a reciprocating piston machine, a scroll expander, a rotary vane machine, or a Roots expander, wherein a helical screw expander is especially preferred. This is especially well-adapted to an ORC process. A continuous-flow machine, especially a turbine, is also possible as an expansion device. The expansion device is preferably functionally connected to a generator, so that the mechanical energy performed in the expansion device can be converted into electrical energy by the generator. The conveying device is preferably configured as a feed pump.

The system preferably comprises ethanol as the working medium. This is especially well-adapted to an ORC process set up to use the waste heat of internal combustion engines.

The system is preferably set up for a mobile application, especially as a mobile ORC system. It is preferably employed to use the waste heat of an internal combustion engine serving to drive a motorized vehicle.

The goal is also achieved in that a control unit for a system for carrying out a thermodynamic cycle, preferably an organic Rankine cycle, is created. The control unit is configured to change the quantity of working medium present in a circuit of the system by actuating a medium quantity-changing device as a function of at least one operating parameter of the system. The control unit is set up to operate a system according to one of the previously described exemplary embodiments. Thus, in conjunction with the control unit, the advantages already explained in connection with the system are realized.

The control unit comprises, in one embodiment, an interface to at least one sensor, by means of which an operating parameter of the system can be detected. Preferably the control unit comprises an interface to a cavitation sensor of the system. Alternatively or in addition, the control unit comprises an interface to a medium quantity-changing device of the system to actuate this device in a manner suitable for changing the quantity of working medium present in the circuit—especially as a function of the at least one operating parameter.

The goal is also achieved in that a method for operating a system for carrying out a thermodynamic cycle, especially preferably for operating a system for an organic Rankine cycle, is created. The method serves preferably to operate a system according to one of the previously described exemplary embodiments. It is characterized in that the quantity of working medium present in a circuit of the system is changed by means of a medium quantity-changing device during operation of the system as a function of at least one operating parameter of the system. As a result, in conjunction with the method, the advantages already explained in connection with the system and the control unit are realized.

In this connection, it has also been found that the control unit is preferably set up to carry out a method for operating a system for a thermodynamic cycle, especially an organic Rankine cycle, according to the previously described embodiment. It is possible for the method to be implemented in an electronic structure, especially in hardware. Alternatively, it is possible for a computer program product to be loaded into the control unit and for this program to contain instructions, on the basis of which the method is carried out when the computer program product is running on the control unit.

Finally, the goal is achieved in that an arrangement is created that comprises an internal combustion engine and a system according to one of the previously described exemplary embodiments. The internal combustion engine and the system are functionally connected to each other in such a way that waste heat of the internal combustion engine is usable in the system. The system is to this extent preferably set up for an organic Rankine cycle. In conjunction with the arrangement, the advantages already explained in connection with the system, the control unit, and the method are realized.

It is preferable for waste heat contained in the exhaust gas of the internal combustion engine to be supplied to the system. Alternatively or in addition, waste heat contained in a coolant of the internal combustion engine can be supplied to the system.

It is possible for a portion of the waste heat in the system to be converted into mechanical energy, which is sent directly back to the internal combustion engine, in that, for example, it is transferred to a crankshaft of the internal combustion engine. Alternatively, it is possible for the mechanical work performed in the system to be converted into electrical energy, wherein it is possible for this energy—preferably by way of an electric motor—to be sent back to the internal combustion engine to support it, in that, for example, the electric motor acts on the crankshaft of the internal combustion engine. Alternatively or in addition, it is possible for the electrical energy generated in the system to be sent to an external consumer or to a power supply system, preferably an on-board power supply system of a motorized vehicle comprising the internal combustion engine.

It is possible for the internal combustion engine of the arrangement to drive a motorized vehicle. It is especially preferred for the arrangement to be provided in a water craft, especially in a ship, preferably in a ferry, wherein the internal combustion engine serves to drive the water craft, especially the ship, preferably the ferry. Electrical energy generated in the system is preferably sent to an on-board power supply system of the water craft. Other mobile applications of the arrangement are also possible. In addition, it is possible for the arrangement to be used in stationary applications such as those in which waste heat is produced during the operation of stationary pumps.

The internal combustion engine of the arrangement is preferably configured as a reciprocating piston engine. In a preferred exemplary embodiment, the internal combustion engine serves in particular to drive heavy land vehicles such as mining vehicles and trains or water craft, wherein the internal combustion engine is used in a locomotive or motor coach or in a ship. The use of the internal combustion engine to drive a vehicle serving defensive purposes such as a tank is also possible. In another exemplary embodiment of the internal combustion engine, it is stationary and used for stationary power generation to generate emergency power or to cover continuous-load or peak-load demands, wherein the internal combustion engine in this case preferably drives a generator. The stationary use of the internal combustion engine to drive auxiliary units such as fire-fighting pumps on offshore drilling rigs is also possible. An application of the internal combustion engine in the area of the recovery of fossil materials and especially fossil fuels such as oil and/or gas is also possible. The internal combustion engine can also be used in industry or in the construction field for the production of construction vehicles such as cranes and bulldozers. The internal combustion engine is preferably configured as a diesel engine; as a gasoline engine; or as a gas engine for operation with natural gas, biogas, customized gas, or some other suitable gas. Especially when the internal combustion engine is configured as a gas engine, it is suitable for use in block-type thermal power stations for stationary power generation.

The description of the system, the control unit, and the arrangement on the one hand and of the method on the other hand are to be understood as complementary to each other. Method steps which are been explained explicitly or implicitly in conjunction with the system, the control unit, or the arrangement are preferably method steps, individually or in combination, of a preferred embodiment of the method. Features of the system, of the control unit, or of the arrangement which have been explained explicitly or implicitly in conjunction with the method are preferably features, individually or in combination, of a preferred embodiment of the system, of the control unit, or of the arrangement. The method is preferably characterized by at least one method step which is required by at least one feature of the system, of the control unit, or of the arrangement. The system, the control unit, or the arrangement is characterized preferably by at least one feature which is required by at least one method step of the method.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a schematic diagram of a first exemplary embodiment of an arrangement with an internal combustion engine and a first exemplary embodiment of the system; and

FIG. 2 shows a schematic diagram of a second exemplary embodiment of an arrangement with an internal combustion engine and a second exemplary embodiment of the system.

### DETAILED DESCRIPTION OF THE INVENTION

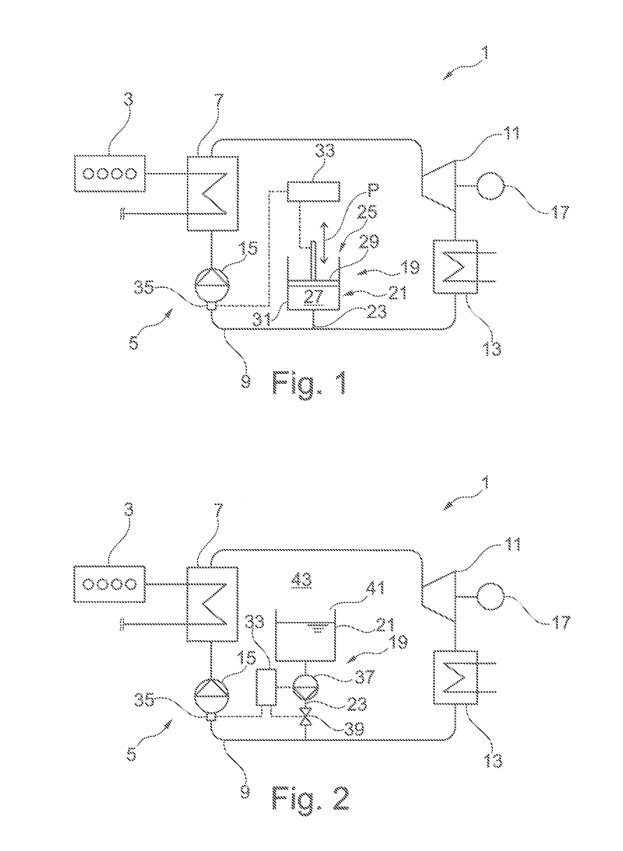

FIG. 1 shows a first exemplary embodiment of an arrangement 1 with an internal combustion engine 3 and a first exemplary embodiment of a system 5 for operating a thermodynamic cycle, here in particular an organic Rankine cycle. The system 5 and the internal combustion engine 3 are functionally connected to each other for the use of waste heat of the internal combustion engine 3. Waste heat contained in the exhaust gas of the internal combustion engine 3 and/or in the coolant of the internal combustion engine 3 can be supplied to the system 5. An exhaust gas line and/or a coolant line of the internal combustion engine 3 is for this purpose thermally coupled to a evaporator 7 in order to transfer the waste heat of the internal combustion engine 3 to the working medium in the evaporator 7 of the system 5 as the working medium circulates around the circuit 9.

Arranged in series along the circuit 9 in the flow direction of the working medium, the system 5 comprises the evaporator 7, in which the working medium, preferably ethanol, is vaporized; an expansion device 11, preferably configured as a helical screw expander, in which the working medium is expanded, wherein it performs mechanical work; a condenser 13, in which the working medium is cooled and preferably recondensed; and finally a conveying device 15, which is preferably configured as a feed pump and which serves to convey the working medium through the circuit 9.

The expansion device 11 is preferably functionally connected to a generator 17, so that the mechanical work performed in the expansion device 11 can be converted into electrical energy by the generator 17. Thus overall a portion of the waste heat taken up in the evaporator 7 is converted in the expansion device 11 into mechanical work, which is then converted in turn into electrical energy by the generator 17. This can be used to support the internal combustion engine 3 or can be sent for external use, especially to a power supply system such as in the on-board power supply system of a motorized vehicle driven by the internal combustion engine 3.

The circuit 9 of such a system 5 typically comprises a permanent, fixed quantity of working medium. This is an essential factor in determining the pressure level in the condenser 13 and thus the power yield of the cycle. The quantity of working medium in the circuit must be as small as possible to optimize the amount of power produced, wherein, however, it also has a lower limit associated with the stability with which the process can be controlled; for example, cavitation can occur in the conveying device 15 if there is not enough working medium in the circuit 9 or if the pressure level in the condenser 13 is too low. In addition, the optimal quantity can vary according to the operating point of the system 5. In the typical case, therefore, a larger quantity of working medium is provided in the circuit 9, so that a safety reserve is present, which guarantees stable operation at every operating point. The sacrifice of power yield is simply tolerated.

To avoid this problem, the system 5 comprises here a working medium quantity-variation device 19, which is connected to the circuit 9 in such a way and so configured that the quantity of working medium present in the circuit 9 can be changed during the operation of the system 5 by means of the medium quantity-variation device 19. For this purpose, the medium quantity-variation device 19 comprises a reservoir 21, which is connected to the circuit 9 by a fluid connection 23.

The reservoir 21 comprises a volume-changing device 25, which is set up to change the filling volume 27 for the working medium in the reservoir 21, therefore, to change the volume available to the working medium in the reservoir. At the same time, the fluid connection 23 is free of control elements or cross section-changing elements, wherein, in particular, it comprises no valves.

In the exemplary embodiment presented here, the volume-changing device 25 comprises a piston 29, which is accommodated movably in a cylinder 31 surrounding the filling volume 27.

Overall, the reservoir 21 is therefore configured as a closed supply tank of variable volume, wherein neither a pump nor a valve is necessary to meter working medium from the reservoir 21 into the circuit 9 or to withdraw working medium from the circuit 9 and send it to the reservoir 21. For this purpose, the piston 29 is movable in the cylinder 31 in the directions indicated by the double arrow P, as a result of which it is possible to increase or decrease the filling volume 27 and thus to force working medium from the reservoir 21 into the circuit 9 or to draw working medium from the circuit 9 into the reservoir 21.

In this way, through suitable actuation of the movement of the piston 29, the quantity of working medium in the circuit 9 can be varied at any time while the system 5 is in operation.

The system 5 comprises a control unit 33, which is functionally connected to the piston 29 to actuate it. The control unit 33 is also functionally connected here to a cavitation sensor 35, wherein the control unit is configured to displace the piston 29 and thus to change the quantity of working medium present in the circuit 9 as a function of a signal sent by the cavitation sensor 35.

The exemplary embodiment shown in FIG. 1 has an especially simple structure, because the medium quantity-variation device 19 requires no pump or valve.

FIG. 2 shows a schematic diagram of a second exemplary embodiment of an arrangement 1 with an internal combustion engine 3 and a second exemplary embodiment of the system 5. Elements which are the same or which serve the same function here are designated by the same reference numbers as those used above, so that to this extent reference is made to the preceding description. In the exemplary embodiment shown here, the medium quantity-variation device 19 comprises a conveying device 37, which is configured here as a pump, and which is set up to convey working medium from the reservoir 21 to the circuit 9 in a first functional position, wherein it is set up to convey working medium from the circuit 9 into the reservoir 21 in a second functional position. The conveying device 37 is therefore preferably configured as a reversible pump, the working direction of which is can be changed as needed. The conveying device 37 is arranged here along the fluid connection 23, i.e., in the fluid connection 23.

A control element 39, which is set up to change the open cross section of the fluid connection 23, is also arranged in the fluid connected 23. The control element 39 is preferably configured as a valve, wherein it is possible for it to be completely open in a first functional position and completely closed in a second functional position. Preferably the control element 39 comprises additional discrete or preferably continuous functional positions between these two extremes.

By means of the conveying device 37, therefore, when the control element 39 is opened, working medium is conveyable either from the reservoir 21 into the circuit 9 or from the circuit 9 into the reservoir 21. The addition or withdrawal of working medium can be achieved in an especially sensitive manner through suitably adapted actuation of the conveying device 37 and/or of the control element 39. The arrangement of the conveying device 37 and of the control element 39 in the fluid connection 23 makes it possible to configure the reservoir 21 as an atmospheric supply tank, wherein the reservoir 21 comprises a pressure equalization connection 41 to an environment 43 of the system 5. The reservoir 21 is therefore preferably pressureless, wherein the circuit 9 can be isolated from the environment 43 in particular by closing the control element 39, so that the pressure in the circuit 9 can be higher, in particular much higher, than the pressure in the environment 43. The conveying device 37 makes it possible to convey working medium from the reservoir 21 into the circuit 9 against the pressure gradient. The pressureless reservoir 21 can be of correspondingly simple configuration, because it has no need to withstand high internal pressure. In addition, the use of a pressureless reservoir 21 increases the safety of the system 5.

The control unit 33 is here again preferably functionally connected to the cavitation sensor 35, also to the conveying device 37, and preferably also to the control element 39 in order to change, preferably automatically to control, the quantity of working medium in the circuit 9 as a function of the signal sent by the cavitation sensor 35.

Overall it can be seen that, in the case of the system 5 proposed here, the control unit 33 and the method make it possible to adjust the pressure level in the condenser 13 through variation of the quantity of working medium in the circuit 9, as a result of which stable operation of the system 5 with optimal power output is possible at every operating point. The system 5 proposed here has a compact and maintenance-free structure in both exemplary embodiments, wherein it comprises a simple structure with only a few movable parts. It is especially well-adapted to exploiting the performance potential of mobile and dynamically operating systems for ORC processes. The automatic control behavior of the system 5 is improved especially during load changes and also during startup and shutdown processes.

While specific embodiments of the invention have been shown and described in detail to illustrate the inventive principles, it will be understood that the invention may be embodied otherwise without departing from such principles.

We claim:

1. A system for a thermodynamic cycle with a circuit for a working medium, comprising a working medium quantity-variation device, which is connected to the circuit and configured so that a quantity of working medium present in the circuit is changeable by the medium quantity-variation device during operation of the system.

2. The system according to claim 1, wherein the medium quantity-variation device comprises a reservoir for the working medium, the reservoir being in fluid connection with the circuit.

3. The system according to claim 2, wherein the reservoir comprises a volume-changing device that is set up to change a filling volume for the working medium in the reservoir.

4. The system according to claim 2, wherein a fluid connection connects the medium quantity-variation device to the circuit, wherein the fluid connection is free of control elements or cross section-changing elements.

5. The system according to claim 3, wherein the volume-changing device comprises a piston that is movably accommodated in a cylinder surrounding the filling volume.

6. The system according to claim 4, further comprising a conveying device arranged to convey working medium from the reservoir into the circuit and/or from the circuit into the reservoir.

7. The system according to claim 6, wherein the conveying device is arranged along the fluid connection.

8. The system according to claim 4, wherein a control element is arranged in the fluid connection, wherein the control element is set up to change a flow cross section of the fluid connection.

9. The system according to claim 2, wherein the reservoir comprises a pressure equalization connection to an environment of the system.

10. The system according to claim 1, further comprising a control unit configured to change the quantity of working medium present in the circuit by the medium quantity-variation device as a function of at least one operating parameter of the system.

11. The system according to claim 10, further comprising a cavitation sensor arranged in an area of a conveying device of the circuit, wherein the control unit is configured to change the quantity of working medium present in the circuit by the medium quantity-variation device as a function of a signal sent by the cavitation sensor.

12. The system according to claim 1, wherein the system is set up for an organic Rankine cycle.

13. A control unit for a system for a thermodynamic cycle according to claim 1, wherein the control unit is configured to change a quantity of working medium present in a circuit of the system by a medium quantity-variation device as a function of at least one operating parameter of the system.

14. A method for operating a system for an organic cycle according to claim 1, wherein a quantity of working medium present in a circuit of the system is changed by a medium quantity-variation device during operation of the system as a function of at least one operating parameter of the system.

15. An arrangement, comprising: an internal combustion engine; and a system according to claim 1, wherein the system is functionally connected to the internal combustion engine so that waste heat of the internal combustion engine is usable in the system.
